(19) United States
(12) Patent Application Publication
(10) Pub. No.: US 2018/0087538 A1
(43) Pub. Date: Mar. 29, 2018

(54) SELF-CONTAINED DEPTH COMPENSATED ACCUMULATOR SYSTEM

(71) Applicant: Allen Russell Gartman, El Lago, TX (US)

(72) Inventor: Allen Russell Gartman, El Lago, TX (US)

(21) Appl. No.: 15/827,345

(22) Filed: Nov. 30, 2017

Related U.S. Application Data
(63) Continuation-in-part of application No. 14/678,839, filed on Apr. 3, 2015, now Pat. No. 9,835,177.
(60) Provisional application No. 61/991,836, filed on May 12, 2014.

(51) Int. Cl. F15B 1/02; F15B 1/033; F15B 1/16; E21B 33/035; E21B 33/064

(52) U.S. Cl. CPC F15B 1/024; F15B 1/033; F15B 1/16; F15B 2211/212; E21B 33/064; F15B 2201/411; E21B 33/0355

(57) ABSTRACT

A self-contained expandable automatic pressure compensated accumulator system for storing and releasing hydraulic fluid energy for use by subsea equipment having a controller, a pressure source, a bidirectional valve fluidly connected to the pressure source, an expandable multisided vessel fluidly connected to the bidirectional valve having a plurality of axial folds between first and second ends, and a bidirectional port connected to the pressure source. As the plurality of axial folds expand, a contracted volume of pressure expands increasing stored hydraulic fluid energy in the expandable multisided vessel. As the plurality of axial folds contract, the expanded volume reduces, releasing stored hydraulic fluid energy to nearby subsea equipment on demand as changes in hydraulic fluid energy requirements for the subsea equipment changes. Simultaneously, hydrostatic seawater pressure of seawater on the expandable multisided vessel is counteracted with the hydrostatic pressure of fluid inside the expandable multisided vessel.

### CROSS REFERENCE TO RELATED APPLICATION

The current application. claims is a Continuation In Part and claims priority to and the benefit of co-pending U.S. patent application Ser. No.: 14/678,839 filed Apr. 3, 2015, entitled “SELF-CONTAINED DEPTH COMPENSATED ACCUMULATOR SYSTEM” and U.S. Provisional Patent Application Ser. No.: 61/991,836 filed on May 12, 2014, entitled “SELF-CONTAINED DEPTH COMPENSATED ACCUMULATOR SYSTEM.” These references is hereby incorporated in its entirety.

### FIELD

The present embodiments generally relate to a subsea accumulator acting as a hydraulic fluid energy storage device for a hydraulic power system.

### BACKGROUND

A need exists for a simple accumulator for subsea hydraulic power systems that operates through supply tubes at great distances, some as long as 120 miles from a hydraulic pressure source and at subsea depths as deep as 15,000 feet below sea level.

A need exists for an accumulator which is not spring charged, as when the spring fails, an undetectable loss of hydraulic fluid energy storage occurs.

A need exists for an accumulator which is not piston based because when piston seals leak the hydraulic fluid teaks into the sea.

A need exists for an accumulator usable at deep ocean depths, more than 5,000 feet, which is flexibly constructed and behaves like a spring without being spring charged.

The present embodiments meet these needs.

### BRIEF DESCRIPTION OF THE FIGURES

The detailed description will be better understood in conjunction with the accompanying drawings as follows:

FIG. 1 depicts a diagram of the system with an expandable multisided vessel in a fully expanded configuration according to one or more embodiments.

FIG. 2A depicts a top perspective view demonstrating the concept of an expandable multisided vessel in a fully contracted configuration according to one or more embodiments.

FIG. 2B depicts a top perspective view demonstrating the concept of an expandable multisided vessel in a partially expanded configuration according to one or more embodiments.

FIG. 3 depicts a partially cut away view of the expandable vessel in the partially expanded configuration according to one or more embodiments.

FIGS. 4A, 4B and 4C depict another embodiment of the expandable multisided vessel in a partially expanded configuration.

FIGS. 5A, 5B and 5C depict another embodiment of the expandable multisided vessel in a partially expanded configuration according to one or more embodiments.

FIGS. 6A, 6B and 6C depict another embodiment of the expandable multisided vessel in a partially expanded configuration according to one or more embodiments.

FIGS. 7A, 7B and 7C depict another embodiment of the expandable multisided vessel in a partially expanded configuration according to one or more embodiments.

FIGS. 8A, 8B and 8C depict another embodiment of the expandable multisided vessel in a partially expanded configuration according to one or more embodiments.

FIGS. 9A, 9B and 9C depict another embodiment of the expandable multisided vessel in a partially expanded configuration according to one or more embodiments.

The present embodiments are detailed below with reference to the listed Figures.

### DETAILED DESCRIPTION OF THE EMBODIMENTS

Before explaining, the present apparatus and system in detail, it is to be understood that the apparatus and system is not limited to the particular embodiments and that it can be practiced or carried out in various ways.

The present embodiments relate to a subsea accumulator that is depth compensated.

The present embodiments relate to an accumulator for subsea use that can have no piston to stick and cause undetected loss of hydraulic fluid energy storage.

The present embodiments relate to an accumulator that can have no piston seals to leak and cause undetected loss of hydraulic fluid energy polluting the sea.

The present embodiments relate to an accumulator that can have no spring to fail and cause undetected loss of hydraulic fluid energy storage. The loss of hydraulic fluid energy causes loss of subsea equipment which could cause wells to erupt causing pollution and damage to wildlife.

The embodiments relate to a flexible accumulator that can have a moveable flexible outer wall that reacts against the hydrostatic pressure of sea water as variable pressure/volume load can be applied to the flexible accumulator.

The term “bidirectional valve” as used herein can refer to a solenoid operated valve, such as a shuttle valve, a gate valve, a ball valve, a butterfly valve, another three way valve, or another at least two way valve capable of withstanding subsea pressures between the subsea equipment and the expandable multisided vessel, such as from 1,500 psi to 20,000 psi.

The term “commands” as used herein can refer to electronic signals that contain at least one bit of information and instruct the bidirectional valve to change state, such as to open or close, communicating user intent to the bidirectional valve. Commands can be transmitted from a controller to the bidirectional valve.

The term “contracted pressurized volume” as used herein can refer to a hydraulic fluid volume when the pressure source provides the hydraulic fluid at a zero pressure, when the axial folds of the expandable multisided vessel are in an initial folded position, the pressure inside the chamber of the expandable multisided vessel equals hydrostatic pressure of the hydraulic fluid at the depth of the expanded vessel.

The term “controller” as used herein can refer to a surface or subsea device adapted to open or close the bidirectional valve of the embodiments using an electric or electronic signal. The controller can open or close the valve based on needs of subsea equipment for hydraulic fluid energy. In embodiments, the controller can be a computer or a programmable logic circuit with computer instructions in the data storage and a processor connected to the data storage.

The term “expanded pressurized volume” as used herein can refer to a hydraulic fluid volume when the pressure source provides the hydraulic fluid at an operating pressure, when the axial folds of the expandable multisided vessel are in an expanded position, the pressure inside the chamber of the expandable multisided vessel equals hydrostatic pressure of the hydraulic fluid at the depth of the expanded vessel plus the operating pressure.

The term “hydraulic fluid” as used herein can refer to oils, water, or another mixture of liquid chemicals, such as corrosion preventive chemicals, which can be pressurized to form hydraulic fluid energy.

The term “hydraulic fluid energy” as used herein can refer to a hydraulic fluid volume which has been pressurized forming hydraulic energy.

The term “pressure source” as used herein can refer to a hydraulic fluid source, such as a tank of hydraulic fluid volume and a pressure pump at sea level which supplies hydraulic fluid energy to the expandable multisided vessel. In embodiments, the pressure pump can operate from 1,500 psi to 20,000 psi.

The term “subsea equipment” as used herein can refer to equipment that can be installed and operating under water, at depths from 30 feet to 20,000 feet and can include but is not limited to blow out preventers, manifolds, Christmas trees, conduits, tubulars, flow line systems, subsea cleaning devices, remotely operated vehicles (ROV) and subsea processing systems.

The embodiments further relate to a self-contained expandable automatic pressure compensated accumulator system for storing and releasing hydraulic fluid energy for use by subsea equipment.

The system can include a pressure source connected to the controller for supplying hydraulic fluid at a defined pressure as “hydraulic fluid energy”.

The system can include a bidirectional valve connected fluidly to the pressure source for transmitting hydraulic fluid energy to subsea equipment.

The bidirectional valve can he electrically connected to the controller for controlling hydraulic fluid energy to and from the subsea equipment based on commands from the controller.

The system can include an expandable multisided vessel fluidly connected to the bidirectional valve.

The expandable multisided vessel can have a first end and a second end. The expandable multisided expandable multisided vessel can have a longitudinal axis between the first end and the second end.

The expandable multisided vessel can have a plurality of axial folds formed contiguously between the first end and the second end creating an outer wall of the expandable multisided vessel.

In embodiments, a pressure containing chamber can be formed between the plurality of axial folds and the first and second ends.

The pressure containing chamber can be configured to have a contracted pressurized volume and an expanded pressurized volume.

The expandable multisided vessel can have a bidirectional port formed in the first end or in the second end. In embodiments, the bidirectional port can be formed along the longitudinal axis.

The bidirectional port can connect simultaneously and in parallel to the pressure source and the bidirectional valve.

The bidirectional port can be configured to provide a flow of hydraulic fluid energy to the bidirectional valve from the pressure containing chamber and a flow of hydraulic fluid energy to the pressure containing chamber from the pressure source.

The embodiments operate so that when the plurality of axial folds expand away from the longitudinal axis, the contracted volume of the pressure containing chamber expands towards an expanded volume increasing stored hydraulic fluid energy in the pressurized chamber, and as the plurality of axial folds contract towards the longitudinal axis, the expanded volume of the pressurized chamber reduces, releasing stored hydraulic fluid energy, enabling the expandable multisided vessel to store retrievable subsea hydraulic fluid energy in close proximity to the subsea equipment and release the stored hydraulic fluid energy on demand as changes in hydraulic fluid energy requirements for the subsea equipment changes, while the expandable multisided vessel simultaneously counteracts the hydrostatic seawater pressure of seawater outside of the expandable multisided vessel with the hydrostatic pressure of hydraulic fluid inside the pressurized chamber.

In embodiments, the self-contained expandable automatic pressure compensated accumulator system can have an expandable multisided vessel with 3 folds to 20 folds.

In embodiments, the self-contained expandable automatic pressure compensated accumulator system supplies hydraulic power to subsea equipment. Examples of subsea equipment can include but is not limited to a blowout preventer, a tubular, a subsea Christmas tree, and a subsea manifold.

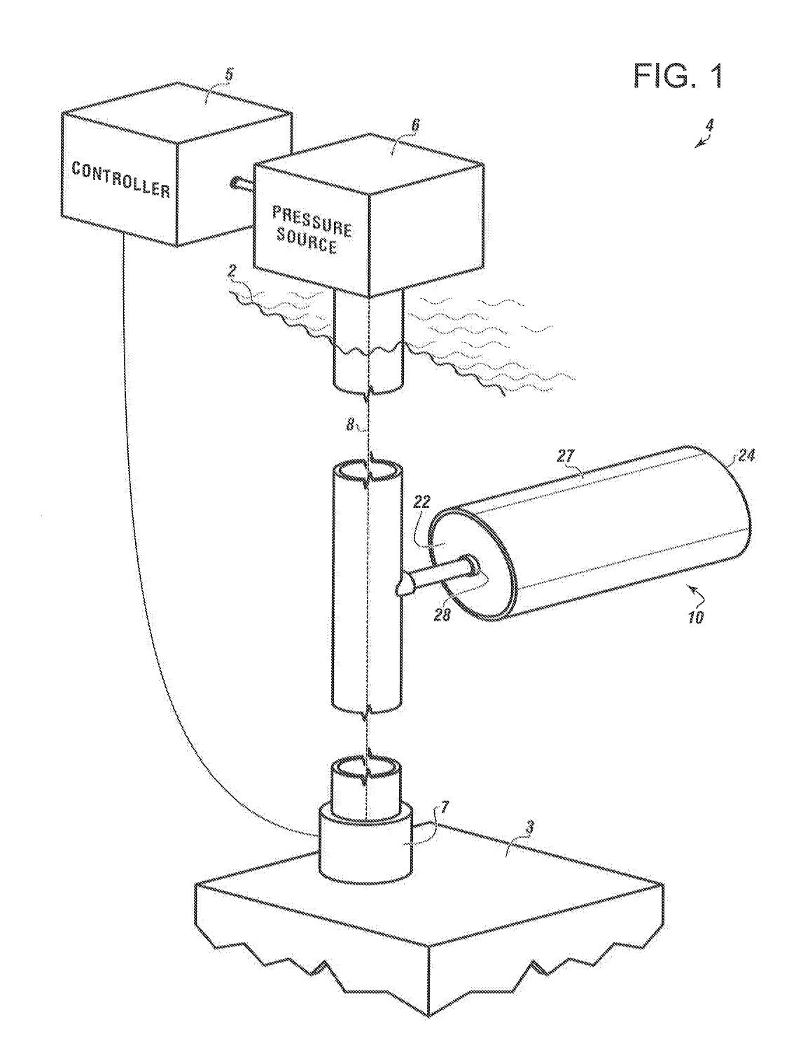

Turning now to the Figures, FIG. 1 depicts a diagram of the system with the expandable multisided vessel in a fully expanded configuration according to one or more embodiments.

The self-contained expandable automatic pressure compensated accumulator system 4 can include a pressure source 6 at the surface of water 2, which can be controlled by a controller 5 to provide hydraulic fluid 8 to a bidirectional port 28 formed in a first end 22 of an expandable multisided vessel 10.

The expandable multisided vessel 10 can have an outer wall 27 formed between the first end 22 and a second end 24.

The bidirectional port 28 can be connected to both the pressure source 6 and a bidirectional valve 7 that controls hydraulic fluid 8 that flows to subsea equipment 3.

The bidirectional port 28 not only provides a flow of hydraulic fluid 8 to the bidirectional valve from the expandable multisided vessel 10 but can also provide a flow of hydraulic fluid 8 to the expandable multisided vessel 10 from the pressure source 6.

The controller 5 can be in electronic communication with the bidirectional valve 7 and can communicate to the subsea equipment 3.

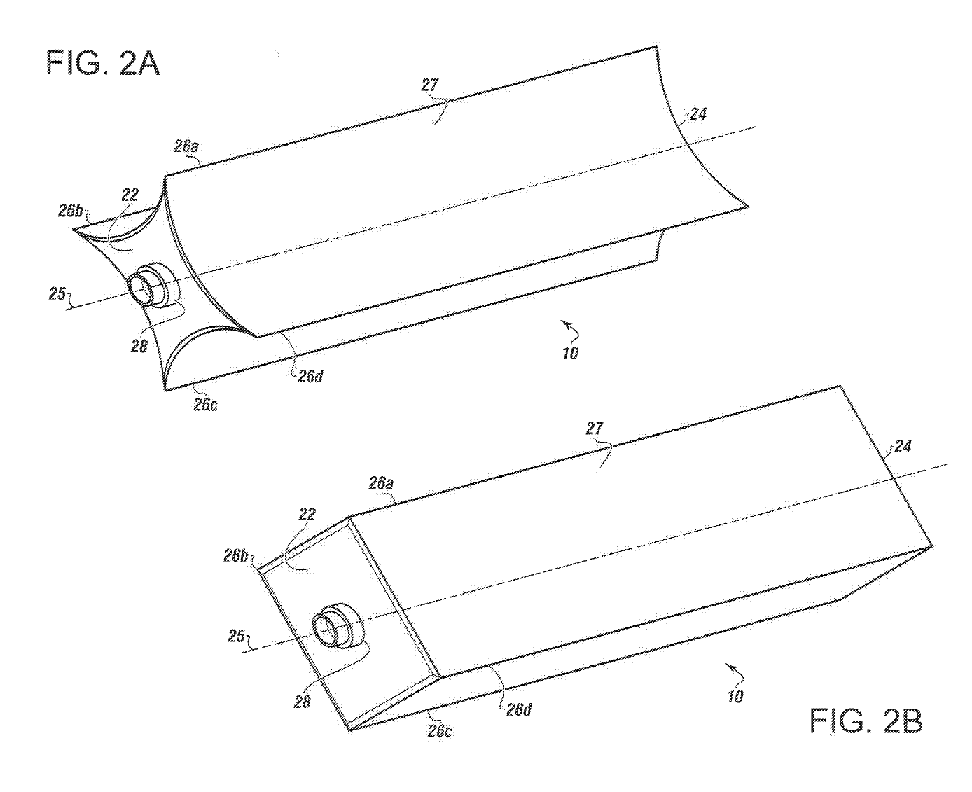

FIG. 2A depicts a top perspective view of the expandable multisided vessel 10 with a longitudinal axis 25 that passes through the bidirectional port 28 in a fully contracted configuration according to one or more embodiments.

In this embodiment, the bidirectional port 28 can be formed in the first end 22 of the contracted configuration.

In this configuration, a plurality of axial folds 26a, 26b, 26c, and 26d can he formed contiguously between the first end 22 and the second end 24 creating the outer wall 27 of the expandable multisided vessel 10.

FIG. 2B depicts a top perspective view of the expandable multisided vessel 10 in a partially expanded configuration according to one or more embodiments.

The plurality of axial folds 26a, 26b, 26c, and 26d can be formed contiguously between the first end 22 and the second end 24 creating a square like shape to the outer wall 27 of the expandable multisided vessel 10.

In this embodiment, the bidirectional port 28 is shown formed in the first end 22 of the partially expanded configuration.

The longitudinal axis 25 is depicted passing through the center of the bidirectional port 28.

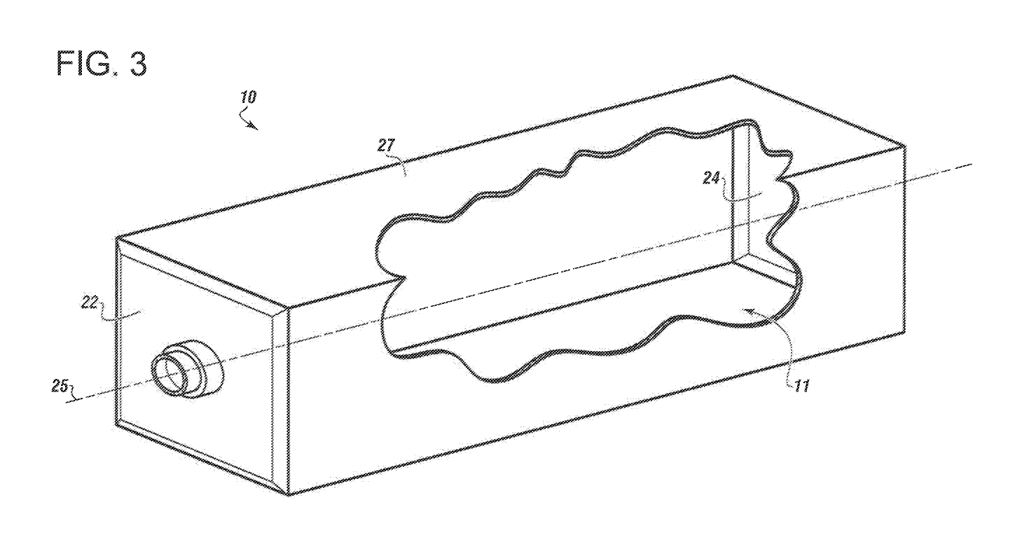

FIG. 3 depicts a partially cut away view of the expandable vessel 10 with longitudinal axis 25 in the partially expanded configuration according to one or more embodiments.

The expandable vessel 10 is shown with the outer wail 27 and the second end 24 opposite the first end 22. In this embodiment, the pressure containing chamber 11 can be configured to have a contracted pressurized volume and an expanded pressurized volume.

The longitudinal axis 25 is depicted passing through the center of the bidirectional port.

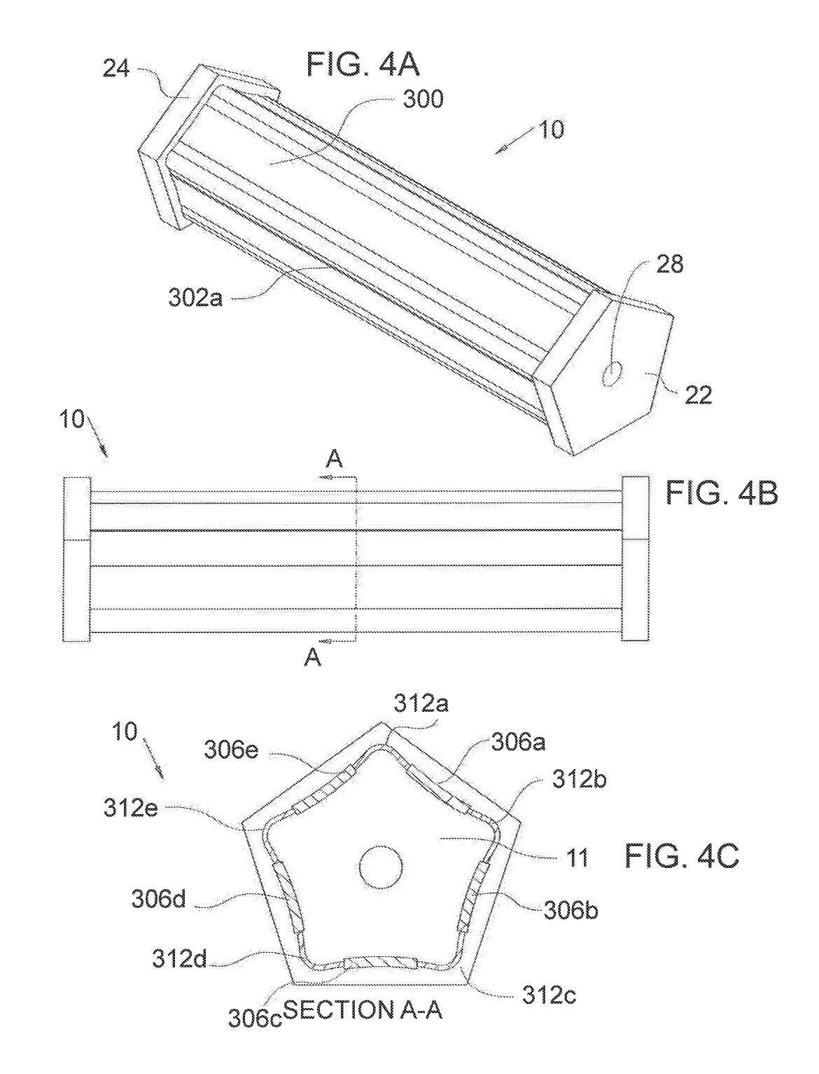

FIGS. 4A-4C depict a view of the expandable multisided vessel 10 in the partially expanded configuration, a side view of the expandable multisided vessel 10 and a cut view of the expandable multisided vessel 10 long cut lines A-A.

The expandable multisided vessel 10 is shown with a moveable flexible rolled metal outer wall 300 and the second end 24 opposite the first end 22.

In embodiments, a pressure containing chamber 11 is configured to have a slightly expanded pressurized volume.

A plurality of axial folds 312a-312e are shown formed contiguously between the first end and the second end.

Each axial fold has a moveable flexible rolled metal outer wall 300 having outer wall folds 302.

A plurality of welded plates 306 are depicted centrally positioned longitudinally on each of the moveable flexible rolled dual thickness metal outer wall.

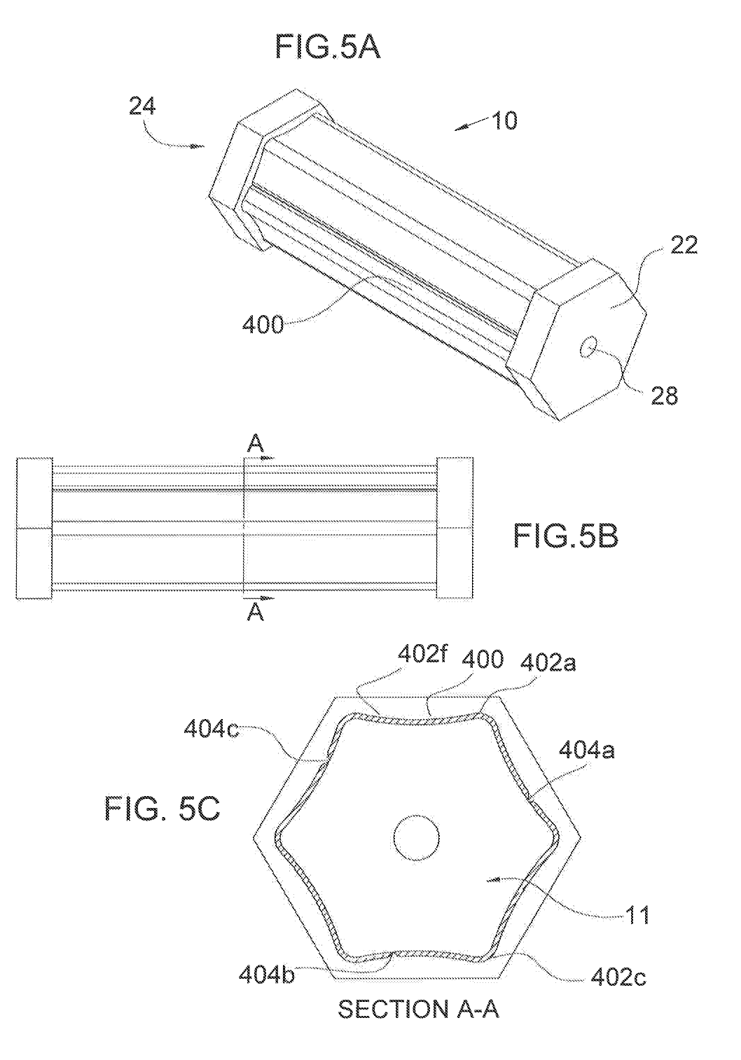

FIGS. 5A-5C show an expandable multisided vessel 10 fluidly connected to the bidirectional valve 7 with a first end 22 opposite a second end 24. The expandable multisided vessel has a plurality of axial folds 402a-402f formed contiguously.

This expandable multisided vessel has a moveable flexible single thickness outer wall 400 having formed and welded outer wall fold.

A plurality of welds 404a-404c is shown to manufacture the outer wall 400.

A pressure containing chamber 11 is configured to have a contracted pressurized volume and an expanded pressurized volume.

As the expandable multisided vessel 10 receives hydraulic fluid energy from the pressure source, the plurality of axial folds 402a-402f forming a moveable flexible extruded metal mono thickness outer wall expand away from the longitudinal axis; the contracted volume formed by the a moveable flexible extruded metal mono thickness outer wall increases, increasing stored hydraulic fluid energy in the pressure containing chamber; and as the expandable multisided vessel receives a demand for hydraulic fluid energy from the subsea equipment, the plurality of axial folds 402a-402f contract towards the longitudinal axis. The expanded volume of the pressure containing chamber reduces releasing stored hydraulic fluid energy, enabling the expandable multisided vessel to store retrievable subsea hydraulic fluid energy in close proximity to the subsea equipment under water and releases the stored hydraulic fluid energy from under water on demand as changes in hydraulic fluid energy requirements for the subsea equipment changes the expandable multisided vessel simultaneously counteracting hydrostatic seawater pressure outside of the a moveable flexible extruded metal dual thickness outer wall with the hydrostatic pressure of hydraulic fluid inside the pressure containing chamber 11.

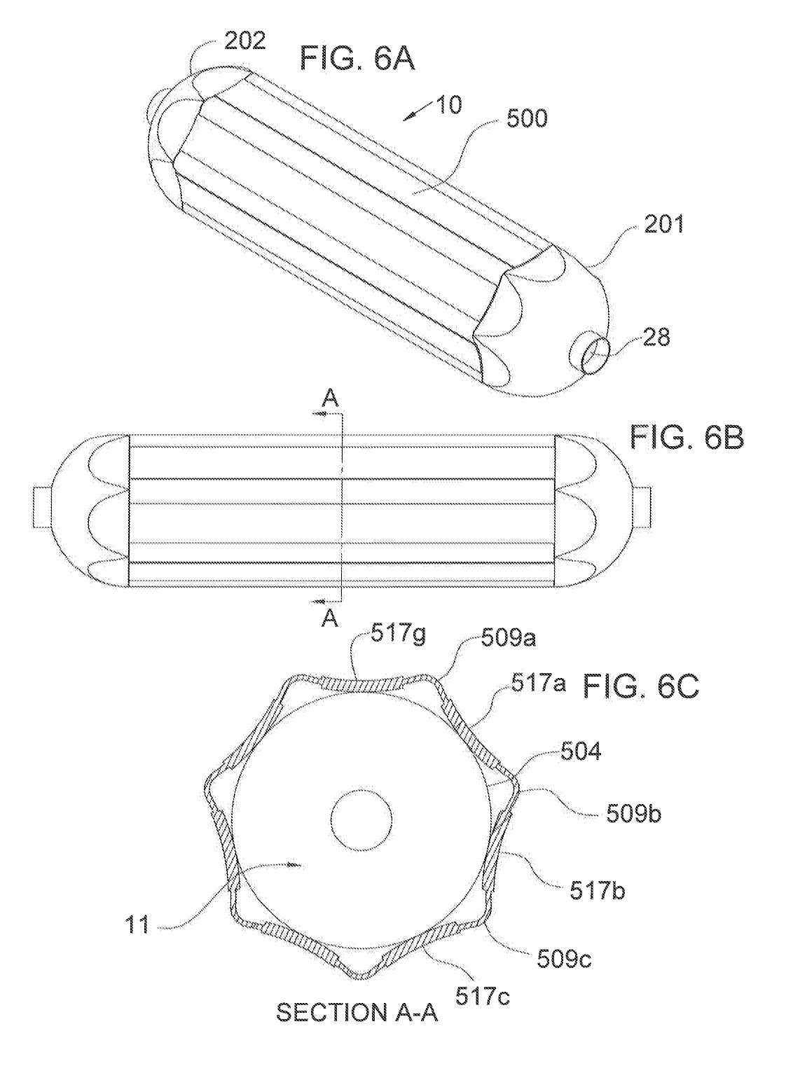

FIGS. 6A-6C show an expandable multisided vessel 10 with a moveable flexible extruded outer wall 500.

A pressure containing chamber 11 is within the outer wall 500, configured to have a contracted pressurized volume and an expanded pressurized volume.

A bidirectional port 28 is formed in the first end or the second end connected to the pressure source and the bidirectional valve, wherein the bidirectional port 28 is configured for flowing through one of the forged end caps 201, 202.

In embodiments, the bidirectional port is configured for flow of hydraulic fluid energy to the bidirectional valve from the pressure containing chamber 11 and a flow of hydraulic fluid energy to the pressure containing chamber from the pressure source.

Axial folds 509a-509g are depicted when the device is viewed along cut lines A-A.

Metal plates 517a-517g are shown.

As the expandable multisided vessel 10 receives hydraulic fluid energy from a pressure source, the plurality of axial folds 509a-509g forming the moveable flexible wound thermoset outer wall expand away from the longitudinal axis; the contracted volume formed by the moveable flexible outer wall increases, increasing stored hydraulic fluid energy in the pressure containing chamber; and as the expandable multisided vessel receives a demand for hydraulic fluid energy from the subsea equipment, the plurality of axial folds contract towards the longitudinal axis. The expanded volume of the pressure containing chamber reduces releasing stored hydraulic fluid energy, enabling the expandable multisided vessel to store retrievable subsea hydraulic fluid energy in close proximity to the subsea equipment under water and release of the stored hydraulic fluid energy from under water on demand as changes in hydraulic fluid energy requirements for the subsea equipment changes the expandable multisided vessel simultaneously counteracting hydrostatic seawater pressure outside of the moveable flexible outer wall with the hydrostatic pressure of hydraulic fluid inside the pressure containing chamber 11.

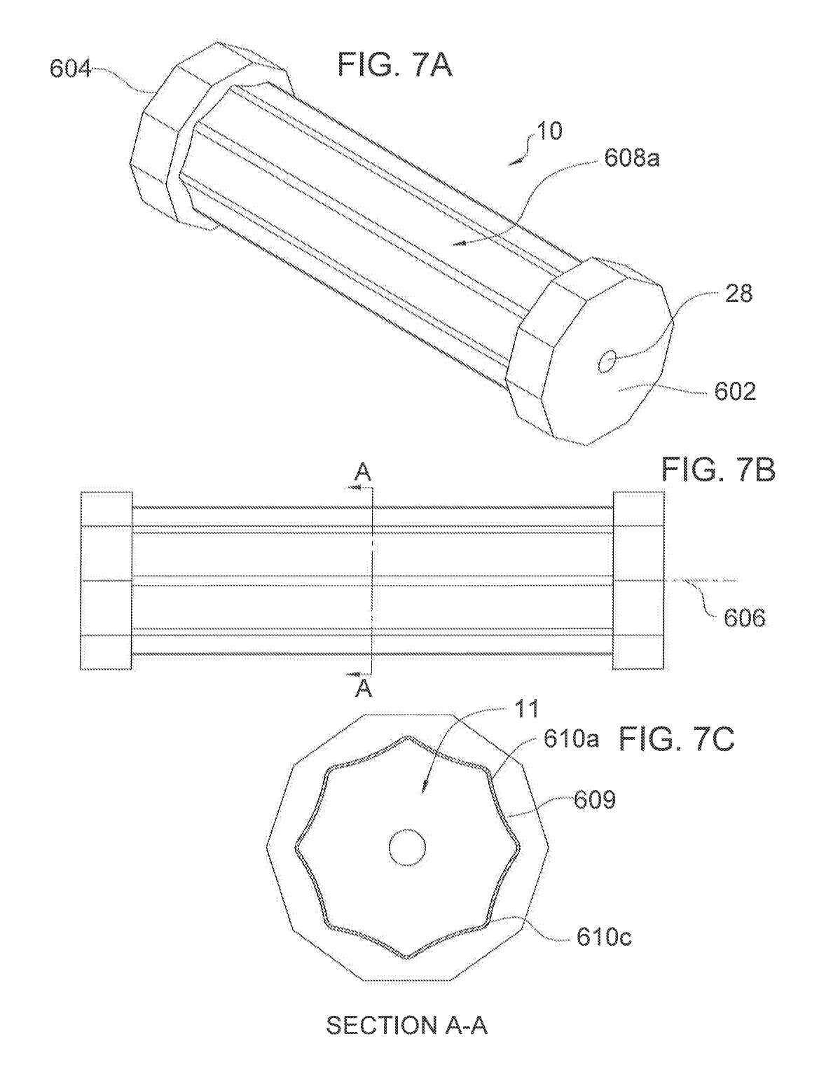

FIGS. 7A-7C shows an expandable multisided vessel 10 with a first polygonal end plate 602, a second polygonal end plate 604 opposite the first metal end plate 602, a longitudinal axis 606 between the first metal end plate 602 and second metal end plate 604.

A plurality of axial folds 610a-610h is formed contiguously between the first and second metal end plates 602, 604.

Each axial fold has a moveable flexible outer wall 609 mandrel formed from a pipe with a plurality of outer wall folds 608a-608h.

A pressure containing chamber 11 configured to have a contracted pressurized volume and an expanded pressurized volume.

A bidirectional port 28 is formed in the first polygonal end plate or the second polygonal end plate connected to the pressure source and the bidirectional valve.

The bidirectional port is configured for a flow of hydraulic fluid energy to the bidirectional valve from the pressure containing chamber and a flow of hydraulic fluid energy from the pressure source to the pressure containing chamber.

As the expandable multisided vessel 10 receives hydraulic fluid energy from the pressure source, the plurality of axial folds forming the moveable flexible outer wall expand away from the longitudinal axis 606; the contracted volume formed by the moveable flexible outer wall increases, increasing stored hydraulic fluid energy in the pressure containing chamber; and as the expandable multisided vessel receives a demand for hydraulic fluid energy from the subsea equipment, the plurality of axial folds contract towards the longitudinal axis. The expanded volume of the pressure containing chamber reduces releasing stored hydraulic fluid energy, enabling the expandable multisided vessel to store retrievable subsea hydraulic fluid energy in close proximity to the subsea equipment under water and releasing the stored hydraulic fluid energy from under water on demand as changes in hydraulic fluid energy requirements for the subsea equipment changes the expandable multisided vessel simultaneously counteracting hydrostatic seawater pressure outside of the moveable flexible outer wall with the hydrostatic pressure of hydraulic fluid inside the pressure containing chamber 11.

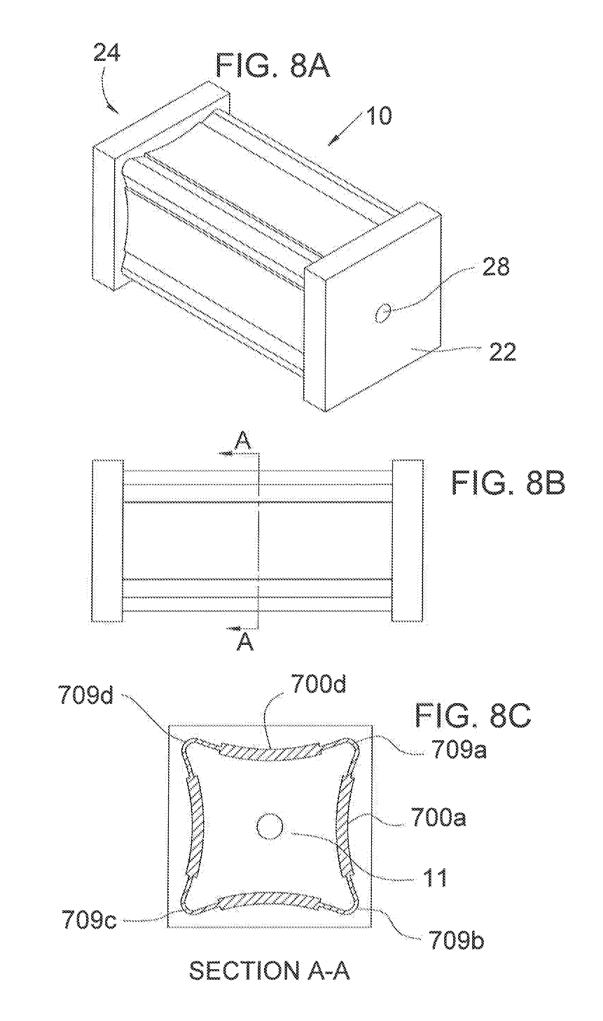

FIGS. 8A-8C show an expandable multisided vessel 10 having a first end 22; a second end 24 opposite the first end, 22 a plurality of axial folds 709a-709d formed contiguously between the first end 22 and the second end 24.

Each axial fold has a moveable flexible laid thermoset outer wall. And a plurality of reinforcing flexible laid thermoset segments 700a-700d when viewed in cross section along lines A-A.

A pressure containing chamber 11 is configured to have a contracted pressurized volume and an expanded pressurized volume.

A bidirectional port is formed in the first end 22 or the second end 24 connected to the pressure source and the bidirectional valve. The bidirectional port is configured for a flow of hydraulic fluid energy to the bidirectional valve from the pressure containing chamber and a flow of hydraulic fluid energy to the pressure containing chamber from the pressure source.

As in other embodiments, as the expandable multisided vessel receives hydraulic fluid energy from the pressure source, the plurality axial folds forming the moveable flexible outer wall expands away from the longitudinal axis; the contracted volume formed by the a moveable flexible outer wall increases, increasing stored hydraulic fluid energy in the pressure containing chamber; and as the expandable multisided vessel receives a demand for hydraulic fluid energy from the subsea equipment, the plurality of axial folds contract towards the longitudinal axis. The expanded volume of the pressure containing chamber reduces, releasing stored hydraulic fluid energy, enabling the expandable multisided vessel to store retrievable subsea hydraulic fluid energy in close proximity to the subsea equipment under water, and releasing the stored hydraulic fluid energy from under water on demand as changes in hydraulic fluid energy requirements for the subsea equipment changes, the expandable multisided vessel simultaneously counteracting hydrostatic seawater pressure outside of the moveable flexible laid thermoset outer wall with the hydrostatic pressure of hydraulic fluid inside the pressure containing chamber 11.

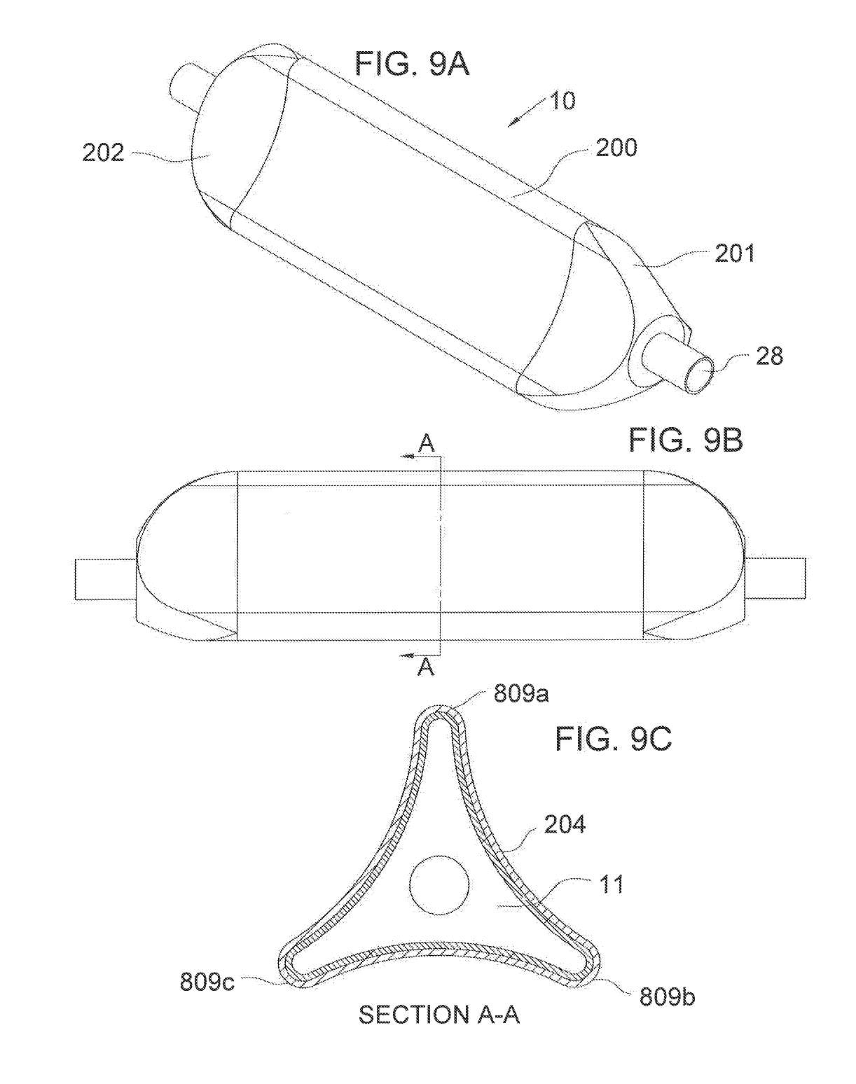

FIGS. 9A-9C show an expandable multisided vessel 10 with a moveable flexible wound thermoset outer wall 200 with a hydroformed metal liner 204 or a thermoplastic liner of a flexible material lining the inner surface.

A pressure containing chamber 11 is within the liner 204, configured to have a contracted pressurized volume and an expanded pressurized volume.

A bidirectional port 28 is formed in the first end or the second end connected to the pressure source and the bidirectional valve, wherein the bidirectional port 28 is configured for flowing through one of the end caps 201.

In embodiments, the bidirectional port 28 is configured for flow of hydraulic fluid energy to the bidirectional valve from the pressure containing chamber 11 and a flow of hydraulic fluid energy to the pressure containing chamber 11 from the pressure source.

Axial folds 809a-809c are depicted when the device is viewed along cut lines A-A.

As the expandable multisided vessel 10 receives hydraulic fluid energy from a pressure source, the plurality of axial folds 809a-809c forming the moveable flexible wound thermoset outer wall expand away from the longitudinal axis; the contracted volume formed by the moveable flexible wound thermoset outer wall increases, increasing stored hydraulic fluid energy in the pressure containing chamber; and as the expandable multisided vessel receives a demand for hydraulic fluid energy from the subsea equipment, the plurality of axial folds contract towards the longitudinal axis. The expanded volume of the pressure containing chamber reduces releasing stored hydraulic fluid energy, enabling the expandable multisided vessel to store retrievable subsea hydraulic fluid energy in close proximity to the subsea equipment under water and release of the stored hydraulic fluid energy from under water on demand as changes in hydraulic fluid energy requirements for the subsea equipment changes the expandable multisided vessel simultaneously counteracting hydrostatic seawater pressure outside of the moveable flexible wound thermoset outer wall with the hydrostatic pressure of hydraulic fluid inside the pressure containing chamber 11.

A typical subsea piston actuated gate valve will need local accumulation to prevent sympathetic closure of other valves on the same piece of subsea equipment when it is opened. The sympathetic closure is caused by the combination of fail-safe valve construction and pipe period.

Subsea valves are designed to fail-safe and not latch; i.e. they have to be held in position with pressure and will start to close if there is any reduction in local pressure below that required to hold them open. An example valve will start to open at 500 psi and be fully open at 1,000 psi. If there is already one valve open and there is no other pressure source, a command to open a second valve will cause the two valves to equalize at 50 percent open and 750 psi, also called “sympathetic closure”.

The low pressure, such as 500 psi start to open., caused by commanding a valve open travels at the speed of sound; typically 1 second to 5 seconds per mile depending on the control fluid and tubing wall design. This low pressure impulse travels from the valve to the pressure source and back again before fluid begins to flow into the actuator from the pressure source and is also called the “pipe period”; i.e. the pipe period equals the offset distance/half the speed of sound.

Given an average pipe period of 6 seconds per mile and typical valve travel period of 20 seconds from closed to open; any valve that is operated at distances greater than 3 miles to 4 miles from the pressure source will complete its opening before fluid begins to flow into it from the remote pressure source. Partially open valves will cause excessive wear to the valve by rubbing against seals and allowing the produced fluids to cut the gate. This valve wear causes the valve to leak and can lead to excessive discharge of reservoir fluids to the sea in the event of the loss of containment. Worn valves must be replaced at extremely high cost due to their location on the seafloor and criticality to safe operation.

A typical control system will have an operating pressure of 5,000 psi. Therefore, a local accumulator can be sized to have sufficient usable volume to fill the largest valve actuator on the subsea equipment while maintaining a minimum of 1,000 psi and thereby preventing sympathetic closure of other valves.

In embodiments, the expandable multisided vessel when partially expanded can have a square shape or other shapes as shown in the Figures.

In other embodiments, the expandable multisided vessel when fully expanded can have a round shape.

The expandable multisided vessel can be expandable and retracted, expanding from the contracted state, to the square state, to the round state, back to the square state, and then to the contracted state.

The expandable multisided vessel can be from 1 foot to 20 feet long, with an initial diameter of 4 inches to 24 inches in diameter.

The thickness of the outer wall of the expandable multisided vessel can vary from 1/16 th of an inch to 6 inches, depending on the pressure source operating pressure.

In embodiments, the expandable multisided vessel can be a one-piece construction of steel, such as stainless steel or “spring steel” which can be a high strength steel, capable of sustaining 50 ksi.

In embodiments, the expandable multisided vessel can be made from a first material for the first and second ends, and a second material for the plurality of axial folds. In embodiments, the first and second ends can be formed from a galvanic compatible material and the plurality of axial folds can be formed from the “spring steel” such as grade ASTM Grade A666 spring steel.

In embodiments, the controller can be remotely controlled from a client device connected to a network that further communicates with the controller, such as a laptop, a computer, a cellular phone, a tablet, or a similar device.

In embodiments, as the plurality of axial folds expand away from the longitudinal axis, the contracted volume of the pressure containing chamber expands towards an expanded volume increasing stored hydraulic fluid energy in the pressure containing chamber. In embodiments, the plurality of axial folds can expand away from the longitudinal axis from 0.001 of a percent to 20 percent of the overall diameter of the expandable multisided vessel.

In embodiments, the expansion of the plurality of axial folds can occur in milliseconds. Similarly, the contraction of the plurality of axial folds can occur in milliseconds.

Similarly, as the plurality of axial folds contract towards the longitudinal axis, the expanded volume of the pressurized chamber reduces releasing stored hydraulic fluid energy, enabling the expandable multisided vessel to store retrievable subsea hydraulic fluid energy in close proximity to the subsea equipment and release the stored hydraulic fluid energy on demand as changes in hydraulic fluid energy requirements for the subsea equipment changes, while the expandable muitisided vessel simultaneously counteracts the hydrostatic seawater pressure of seawater outside of the expandable multisided vessel with the hydrostatic pressure of hydraulic fluid inside the pressurized chamber. In embodiments, the plurality of axial folds can retract from 0.001 of a percent to 20 percent of the overall diameter of the expandable multi sided vessel.

The plurality of axial folds can expand and retract without frictional losses.

While these embodiments have been described with emphasis on the embodiments, it should be understood that within the scope of the appended claims, the embodiments might be practiced other than as specifically described herein.

What is claimed is:

1. A self-contained expandable automatic pressure compensated accumulator system for storing and releasing hydraulic fluid energy for use by subsea equipment under water, the self-contained expandable automatic pressure compensated accumulator system comprising:
a. a controller;
b. a pressure source connected to the controller for supplying hydraulic fluid at a defined pressure as hydraulic fluid energy;
c. a bidirectional valve connected:
(i) fluidly to the pressure source for transmitting the hydraulic fluid energy to the subsea equipment; and
(ii) electrically connected to the controller for controlling the hydraulic fluid energy to and from the subsea equipment based on commands from the controller; and
d. an expandable multisided vessel fluidly connected to the bidirectional valve, the expandable multisided vessel comprising:
(i) a first end;
(ii) a second end opposite the first end;
(iii) a longitudinal axis between the first end and the second end;
(iv) a plurality of axial folds formed contiguously between the first end and the second end, each axial fold comprising:
(a) an moveable flexible outer wall with an inner surface,
(b) at least one liner, lining the inner surface;
(c) a pressure containing chamber configured to have a contracted pressurized volume and an expanded pressurized volume; and
(v) a bidirectional port formed in the first end or the second end connected to the pressure source and the bidirectional valve, wherein the bidirectional port is configured for:
a) a flow of the hydraulic fluid energy to the bidirectional valve from the pressure containing chamber; and
(b) a flow of the hydraulic fluid energy to the pressure containing chamber from the pressure source; and
wherein, as the expandable muitisided vessel receives the hydraulic fluid energy from the pressure source, the plurality of axial folds forming the moveable flexible wound thermoset outer wall expand away from the longitudinal axis; the contracted volume formed by the moveable flexible wound thermoset outer wall increases, increasing stored the hydraulic fluid energy in the pressure containing chamber; and as the expandable multisided vessel receives a demand for the hydraulic fluid energy from the subsea equipment, the plurality of axial folds contract towards the longitudinal axis; the expanded volume of the pressure containing chamber reduces releasing stored hydraulic fluid energy, enabling the expandable multisided vessel to store retrievable subsea hydraulic fluid energy in close proximity to the subsea equipment under water, and releasing the stored hydraulic fluid energy from under water on demand as changes in hydraulic fluid energy requirements for the subsea equipment changes the expandable muitisided vessel simultaneously counteracting hydrostatic seawater pressure outside of the moveable flexible wound thermoset outer wall with the hydrostatic pressure of hydraulic fluid inside the pressure containing chamber.

2. The self-contained expandable automatic pressure compensated accumulator system of claim 1, wherein the expandable multisided vessel comprises from 2 folds to 20 folds.

3. The self-contained expandable automatic pressure compensated accumulator system of claim 1, wherein the subsea equipment is at least one of: a blowout preventer, a tubular, a subsea Christmas tree, and a subsea manifold.

4. The self-contained expandable automatic pressure compensated accumulator system of claim 1, wherein the at least liner is at least one of a hydroformed metal liner and a thermoplastic liner of a flexible material.

5. The self-contained expandable automatic pressure compensated accumulator system of claim 4, wherein the hydroformed metal liner is at least one of a metal and plastic layer.

6. The self-contained expandable automatic pressure compensated accumulator system of claim 1, each axial fold comprising a moment hinge when a thicknesses changes in the axial fold.

7. The self-contained expandable automatic pressure compensated accumulator system of claim 1, wherein the moveable flexible outer wall is a wound thermoset outer wall.

8. A self-contained expandable automatic pressure compensated accumulator system for storing and releasing hydraulic fluid energy for use by subsea equipment under water, the self-contained expandable automatic pressure compensated accumulator comprising:
a. a controller;
b. a pressure source connected to the controller for supplying hydraulic fluid at a defined pressure as hydraulic fluid energy;
c. a bidirectional valve connected:
(i) fluidly to the pressure source for transmitting the hydraulic fluid energy to the subsea equipment; and
(ii) electrically connected to the controller for controlling the hydraulic fluid energy to and from the subsea equipment based on commands from the controller; and
d. an expandable multisided vessel fluidly connected to the bidirectional valve, the expandable multisided vessel comprising:
(i) a first end;
(ii) a second end opposite the first end;
(iii) a longitudinal axis between the first end and the second end;
(iv) a plurality of axial folds formed contiguously between the first end and the second end, each axial fold of the plurality of axial folds comprising:
(a) a moveable flexible rolled metal outer wall comprising outer wall folds;
(b) a plurality of welded plates centrally positioned longitudinally on each of the moveable flexible rolled metal outer wall;
(c) a pressure containing chamber configured to have a contracted pressurized volume and an expanded pressurized volume; and
(v) a bidirectional port formed in the first end plate or the second end plate connected to the pressure source and the bidirectional valve, wherein the bidirectional port is configured for:
(a) a flow of the hydraulic fluid energy to the bidirectional valve from the pressure containing chamber; and
(b) a flow of the hydraulic fluid energy from the pressure source to the pressure containing chamber; and
wherein, as the expandable multisided vessel receives the hydraulic fluid energy from the pressure source, the plurality axial folds forming the moveable flexible rolled metal outer wall expand away from the longitudinal axis; the contracted volume formed by the moveable flexible rolled metal outer wall increases, increasing the stored hydraulic fluid energy in the pressure containing chamber; and as the expandable multisided vessel receives a demand for the hydraulic fluid energy from the subsea equipment, the plurality of axial folds contract towards the longitudinal axis; the expanded volume of the pressure containing chamber reduces releasing stored hydraulic fluid energy, enabling the expandable multisided vessel to store retrievable subsea hydraulic fluid energy in close proximity to the subsea equipment under water, and releasing the stored hydraulic fluid energy from under water on demand as changes in hydraulic fluid energy requirements for the subsea equipment changes the expandable multisided vessel simultaneously counteracting hydrostatic seawater pressure outside of the moveable flexible rolled metal outer wall with the hydrostatic pressure of hydraulic fluid inside the pressure containing chamber.

9. The self-contained expandable automatic pressure compensated accumulator system of claim 8, further comprising from 2 folds to 20 folds.

10. The self-contained expandable automatic pressure compensated accumulator system of claim 8, further comprising a plurality of segments forming a second outer wall welded to the moveable flexible rolled metal outer wall.

11. The self-contained expandable automatic pressure compensated accumulator system of claim 8, wherein the subsea equipment is at least one of: a blowout preventer, a tubular, a subsea Christmas trees, and a subsea manifold.

12. The self-contained expandable automatic pressure compensated accumulator system of claim 8, wherein the moveable flexible rolled metal outer wall comprises a plurality of moment hinges.

13. The self-contained expandable automatic pressure compensated accumulator system of claim 8, wherein each end is a forged end cap.

14. The self-contained expandable automatic pressure compensated accumulator system of claim 8, wherein each axial fold is a mandrel formed axial fold.

15. A self-contained expandable automatic pressure compensated accumulator system for storing and releasing hydraulic fluid energy for use by subsea equipment, the self-contained expandable automatic pressure compensated accumulator system comprising:
a. a controller;
b. a pressure source connected to the controller for supplying hydraulic fluid at a defined pressure as hydraulic fluid energy;
c. a bidirectional valve connected:
(i) fluidly to the pressure source for transmitting the hydraulic fluid energy to subsea equipment; and
(ii) electrically connected to the controller for controlling the hydraulic fluid energy to and from the subsea equipment based on commands from the controller; and
d. an expandable multisided vessel fluidly connected to the bidirectional valve, the expandable multisided vessel comprising:
(i) a first end;
(ii) a second end opposite the first end;
(iii) a longitudinal axis between the first end and the second end;
(iv) a plurality of axial folds formed contiguously between the first end and the second end, each axial fold of the plurality of axial folds comprising:
(a) a moveable flexible laid thermoset outer wall;
(b) a plurality of reinforcing flexible laid thermoset segments;
(c) a pressure containing chamber configured to have a contracted pressurized volume and an expanded pressurized volume; and
(v) a bidirectional port formed in the first end or the second end connected to the pressure source and the bidirectional valve, wherein the bidirectional port is configured for:
(a) a flow of the hydraulic fluid energy to the bidirectional valve from the pressure containing chamber; and
(b) a flow of the hydraulic fluid energy to the pressure containing chamber from the pressure source; and
wherein, as the expandable multisided vessel receives the hydraulic fluid energy from the pressure source, the plurality axial folds forming the moveable flexible laid thermoset outer wall expands away from the longitudinal axis; the contracted volume formed by the a moveable flexible laid thermoset outer wall increases, increasing the stored hydraulic fluid energy in the pressure containing chamber; and as the expandable multisided vessel receives a demand for the hydraulic fluid energy from the subsea equipment, the plurality of axial folds contract towards the longitudinal axis; the expanded volume of the pressure containing chamber reduces releasing the stored hydraulic fluid energy, enabling the expandable multisided vessel to store retrievable subsea hydraulic fluid energy in close proximity to the subsea equipment under water, and releasing the stored hydraulic fluid energy from under water on demand as changes in hydraulic fluid energy requirements for the subsea equipment changes the expandable multisided vessel simultaneously counteracting hydrostatic seawater pressure outside of the moveable flexible laid thermoset outer wall with the hydrostatic pressure of hydraulic fluid inside the pressure containing chamber.

16. A self-contained expandable automatic pressure compensated accumulator system for storing and releasing hydraulic fluid energy for use by subsea equipment, the self-contained expandable automatic pressure compensated accumulator system comprising:
a. a controller;
b. a pressure source connected to the controller for supplying hydraulic fluid at a defined pressure as hydraulic fluid energy;
c. a bidirectional valve connected:
(i) fluidly to the pressure source for transmitting the hydraulic fluid energy to subsea equipment; and
(ii) electrically connected to the controller for controlling the hydraulic fluid energy to and from the subsea equipment based on commands from the controller; and
d. an expandable multisided vessel fluidly connected to the bidirectional valve, the expandable multisided vessel comprising:
(i) an end cap;
(ii) an end cap opposite the first bell end plate;
(iii) a longitudinal axis between the first and second end caps;
(iv) a plurality of axial folds formed contiguously between the first and second end caps, creating:
(a) a moveable flexible extruded metal dual thickness outer wall having formed outer wall folds;
(b) a pressure containing chamber configured to have a contracted pressurized volume and an expanded pressurized volume; and
(v) a bidirectional port formed in the first end cap or the second end cap connected to the pressure source and the bidirectional valve, wherein the bidirectional port is configured for:
(a) a flow of the hydraulic fluid energy to the bidirectional valve from the pressure containing chamber; and
(b) a flow of the hydraulic fluid energy from the pressure source to the pressure containing chamber; and
wherein, as the expandable multisided vessel receives the hydraulic fluid energy from the pressure source, the plurality of axial folds forming the a moveable flexible extruded metal dual thickness outer wall expand away from the longitudinal axis; the contracted volume formed by the a moveable flexible extruded metal dual thickness outer wall increases, increasing the stored hydraulic fluid energy in the pressure containing chamber; and as the expandable multisided vessel receives a demand for the hydraulic fluid energy from the subsea equipment, the plurality of axial folds contract towards the longitudinal axis; the expanded volume of the pressure containing chamber reduces releasing stored hydraulic fluid energy, enabling the expandable multisided vessel to store retrievable subsea hydraulic fluid energy in close proximity to the subsea equipment under water, and releasing the stored hydraulic fluid energy from under water on demand as changes in hydraulic fluid energy requirements for the subsea equipment changes the expandable multisided vessel simultaneously counteracting hydrostatic seawater pressure outside of the a moveable flexible thickness outer wall with the hydrostatic pressure of hydraulic fluid inside the pressure containing chamber.

17. A self-contained expandable automatic pressure compensated accumulator system for storing and releasing hydraulic fluid energy for use by subsea equipment, the self-contained expandable automatic pressure compensated accumulator system comprising:
a. a controller;
b. a pressure source connected to the controller for supplying hydraulic fluid at a defined pressure as hydraulic fluid energy;
c. a bidirectional valve connected:
(i) fluidly to the pressure source for transmitting the hydraulic fluid energy to subsea equipment; and
(ii) electrically connected to the controller for controlling the hydraulic fluid energy to and from the subsea equipment based on commands from the controller; and
d. an expandable multisided vessel fluidly connected to the bidirectional valve, the expandable multisided vessel comprising
(i) a first metal end plate;
(ii) a second metal end plate opposite the first metal end plate;
(iii) a longitudinal axis between the first and second metal end plates;
(iv) a plurality of axial folds formed contiguously between the first and second metal end plates, each axial fold comprising:
(a) a moveable flexible outer wall formed from a pipe
(b) a plurality of outer wall folds;
(c) a pressure containing chamber configured to have a contracted pressurized volume and an expanded pressurized volume; and
(v) a bidirectional port formed in the first polygonal end plate or the second polygonal end plate connected to the pressure source and the bidirectional valve, wherein the bidirectional port is configured for:
1. a flow of the hydraulic fluid energy to the bidirectional valve from the pressure containing chamber; and
2. a flow of the hydraulic fluid energy from the pressure source to the pressure containing chamber; and
wherein, as the expandable multisided vessel receives the hydraulic fluid energy from the pressure source, the plurality of axial folds forming the moveable flexible outer wall expand away from the longitudinal axis; the contracted volume formed by the moveable flexible outer wall increases, increasing the stored hydraulic fluid energy in the pressure containing chamber; and as the expandable multisided vessel receives a demand for the hydraulic fluid energy from the subsea equipment, the plurality of axial folds contract towards the longitudinal axis; the expanded volume of the pressure containing chamber reduces releasing stored hydraulic fluid energy, enabling the expandable multisided vessel to store retrievable subsea hydraulic fluid energy in close proximity to the subsea equipment under water, and releasing the stored hydraulic fluid energy from under water on demand as changes in hydraulic fluid energy requirements for the subsea equipment changes the expandable multisided vessel simultaneously counteracting hydrostatic seawater pressure outside of the moveable flexible outer wall with the hydrostatic pressure of hydraulic fluid inside the pressure containing chamber.
